(19) United States
(12) Patent Application Publication
(10) Pub. No.: US 2005/0108415 A1
(43) Pub. Date: May 19, 2005

(54) System and method for traffic analysis

(76) Inventors: Doughan A. Turk, Toronto (CA); Ronald Mark Seguin, Ottawa (CA)

Correspondence Address: TORYS LLP, 79 WELLINGTON ST. WEST, SUITE 3000, TORONTO, ON, M5K 1N2, CA

(21) Appl. No.: 10/699,685

(22) Filed: Nov. 4, 2003

(51) Int. Cl. G06F 15/16

(52) U.S. Cl. 709/232

(57) ABSTRACT

The present invention provides a system and method for traffic analysis. Embodiments can be used to detect malevolent network activity such as worms, viruses, denial of service attacks, and unauthorized network routing. Upon detecting the activity, steps can then be taken to halt the spread and/or remove the malevolent network activity, thereby adding protection from such activity to the network. Other network activity of interest can also be detected.

### FIELD OF THE INVENTION

The present invention relates generally to computer networking and more particularly to a system and method for analyzing network traffic.

### BACKGROUND OF THE INVENTION

Viruses, worms, and other types of malevolent code and malicious activities are a regular cause of disruption, delay, and downtime in the Internet and other types of networks. The Code Red virus and the Blaster worm are but two examples of malevolent code that caused enormous disruption to the Internet and the users who rely on the Internet. Common techniques to combat malevolent code include the use of virus software, patches and firewalls etc. resident at subscriber equipment. For example, virus software such as Norton Antivirus is a way to ‘disinfect’ a computer that has a worm or virus. To perform such disinfection, the virus software is updated from time-to-time with virus definitions that equip the software to identify and remove the offending code. The obvious downside to virus software is that very often, at least one infection must occur before a corresponding virus definition to combat the infection can be prepared and distributed. Another disadvantage with virus software is that the virus software actually needs to be installed on the subscriber computer, which can in and of itself impair the overall performance of the computer as the virus software occupies memory and processing time.

“Patches” are also a common approach taken by operating system vendors, such as Microsoft, who offer upgrades and patches to the operating system to try and close the various security loopholes in their operating systems that render computers vulnerable to infection. Firewalls, both hardware and software based, are still a further way to try and prevent infections. One means of protection offered by firewalls is the ability to ‘stealth’ or ‘close’ certain Internet Protocol (IP) ports that are commonly used to attack a computer. However, a firewall can only reduce the likelihood of infection, and does not overcome all security loopholes present in the subscriber computers that they are intended to protect. In general, subscriber-side protection against malevolent activity tends to be reactive and only reduces the likelihood of infection, leaving room for solutions that can further reduce the likelihood of infection and/or rapid detection and isolation thereof.

To address some of these shortcomings, one approach is to increase the amount of combative-activity being conducted on the portion of the Internet (or other network) belonging to the service provider (or equivalent). In general, techniques and devices are used by the service provider in an attempt to catch malevolent code before it infects a subscriber's computer, or at least before too many subscriber computer's are infected. Arbor Networks Inc., of 430 Bedford Street, Suite 160, Lexington, Mass. 02420, USA (http://www.arbornetworks.com) proposes a solution for identifying and/or eliminating “network-wide anomalies, such as DDoS attacks, worms, router attacks, instability, and policy violations”. (See http://www.arbornetworks.com) The solution includes at least one network router, through which all traffic for a particular Internet Service Provider (“ISP”) will flow. The network router in the Arbor Networks solution catalogues network traffic, and performs a degree of traffic aggregation for the purpose of analysis. In general, however, the Abor Networks solution provides limited analysis, performing a simple aggregation traffic based on the traffic source. Since fairly limited information can be gleaned from this aggregation—the network service provider is faced with the problem of performing their own, more detailed analysis. In the end, the Arbor Networks solution itself only reduces In general, subscriber-side protection against malevolent activity tends to be reactive and only reduces the likelihood of infection, leaving room for solutions that can further reduce the likelihood of infection and/or rapid detection and isolation thereof.

### SUMMARY OF THE INVENTION

It is an object of the present invention to provide a novel system and method for traffic analysis that obviates or mitigates at least one of the above-identified disadvantages of the prior art.

An aspect the invention provides a system for analyzing network traffic comprising a plurality of subscriber units and a default router interconnected by a network. The network is operable to direct routed traffic to an appropriate subscriber unit and is further operable to direct unrouted traffic to the default route generator. The system also comprises an analyzer connected to the default router for determining patterns of activity within the unrouted traffic.

The activity can be selected from the group consisting of worms, viruses, Trojan horses, scanners.

The activity can also be a misconfiguration of a network routing table in a second network adjacent to the network. The misconfiguration can be a result of the second network routing traffic to a third network adjacent the network via the network. The misconfiguration can result in a breach of a service contract between an operator of the network and an operator of the second network, and so the system can also include a means for assessing a penalty against an operator of the second network, the penalty corresponding to the breach of contract.

At least one of the patterns that can be detected is a plurality of attempts by one of the subscriber units to send unrouted traffic. The pattern can also be characterized by the fact that the attempts occur at substantially identical intervals of time.

At least one of the patterns that can be detected includes a subscriber unit originating unrouted traffic from at least one predefined port and attempting to send traffic to another at least one predefined port.

At least one of the patterns that can be detected is includes a subscriber unit originating traffic of a first type of protocol.

The system can further comprise a honey pot connected to the analyzer for responding to the unrouted traffic. The honey pot can be operable to permit itself to be infected with a malicious code associated with the unrouted traffic. The honey pot can include a malicious code scanner for identifying the malicious code once the honey pot computer is infected.

The system can further comprise a means for isolating one of the subscriber units from the network if the analyzer determines a pattern of activity associated therewith is malicious.

The system can further comprise a means for notifying one of the subscriber units if the analyzer determines a pattern of activity associated therewith is malicious.

The system can further comprise a means for charging a fee to a subscriber associated with the one of the subscriber units.

The system can further comprise a means for providing the analyzer with updated definitions of known patterns of malicious traffic.

Another aspect of the invention provides a traffic analyzer comprising an interface for connecting to a network. The network is operable to interconnect a plurality of subscriber units. The network is further operable to direct routed traffic to an appropriate subscriber unit and is further operable to direct unrouted traffic to the interface. The traffic analyzer also comprises a processing means connected to the interface. The processing means is operable to determine patterns of activity within the unrouted traffic.

Another aspect of the invention provides a default router for connecting to a network that interconnects a plurality of subscriber units. The network is operable to direct routed traffic in the network to an appropriate subscriber unit. The default router is operable to instruct the network to direct unrouted traffic to the default route generator. The network further includes a routing table and the default router is operable to instruct the network to direct unrouted traffic to the default router by creating an entry in the routing table associated with the default route generator.

Another aspect of the invention provides a network routing table for use in association with a network that interconnects a plurality of subscriber units. The network is operable to access the network routing table to direct routed traffic in the network to an appropriate subscriber unit. The network is further operable to access the network routing table to direct unrouted traffic in the network to a traffic analyzer.

Another aspect of the invention provides a method of analyzing traffic in a network comprising the steps of:
receiving traffic from at least one of a plurality of subscriber units interconnected by the network;
delivering the traffic to a destination subscriber unit if the traffic is routed;
analyzing the traffic for patterns of activity in the traffic if the traffic is unrouted.

The method can further comprise the step of assessing a penalty against an operator of the second network, the penalty corresponding to the breach of contract.

The method can further comprise the step of-responding to the unrouted traffic. The method can further comprise the step of step of permitting an infection in a honey pot computer of a malicious code in associated with the unrouted traffic. The method can further comprise the step of after the permitting step, of scanning the honeypot computer to identify the malicious code.

The method can further comprise the step of isolating one of the subscriber units from the network if the pattern of activity associated with the one of the subscriber units is determined to be malicious.

The method can further comprise the step of notifying one of the subscriber units if the pattern of activity associated with the one of the subscriber units is determined to be malicious.

The method can further comprise the step of charging a fee to a subscriber associated with the one of the subscriber units.

The method can further comprise the step of providing updated definitions of known patterns of malicious traffic.

The method can further comprise the step of notifying one of the subscriber units if the pattern of activity associated with the one of the subscriber units is determined to be malicious, the notifying including offering a software tool for removing code from the at least one subscriber unit that is responsible for generating such malicious activity.

Another aspect of the invention provides a system comprising:
means for receiving network traffic from at least one subscriber unit coupled to a network; and
means for detecting an infection problem on the subscriber unit with use of the received network traffic.

The system can further comprise means for offering to a person associated with the subscriber unit, an application to at least one of protect and destroy the infection problem if an infection problem is detected on the subscriber unit.

### BRIEF DESCRIPTION OF THE DRAWINGS

The invention will now be described by way of example only, and with reference to the accompanying drawings, in which:

FIG. 1 is a schematic representation of a system for traffic analysis in accordance with an embodiment of the invention;

FIG. 2 is a flow chart depicting a method for traffic analysis in accordance with another embodiment of the invention;

FIG. 3 shows the system of FIG. 1 with a certain path of traffic therethrough;

FIG. 4 shows the system of FIG. 1 with a certain path of traffic therethrough;

FIG. 5 is a schematic representation of a system for traffic analysis in accordance with another embodiment of the invention;

FIG. 6 is a schematic representation of a system for traffic analysis in accordance with another embodiment of the invention;

FIG. 7 shows the system of FIG. 6 with a certain path of traffic therethrough;

FIG. 8 shows the system of FIG. 6 with a certain path of traffic therethrough when the system of FIG. 6 is misconfigured;

FIG. 9 shows the system of FIG. 6 with a certain path of traffic therethrough when the system of FIG. 6 is misconfigured; and,

FIG. 10 is a schematic representation of a system for traffic analysis in accordance with another embodiment of the invention.

### DETAILED DESCRIPTION OF THE INVENTION

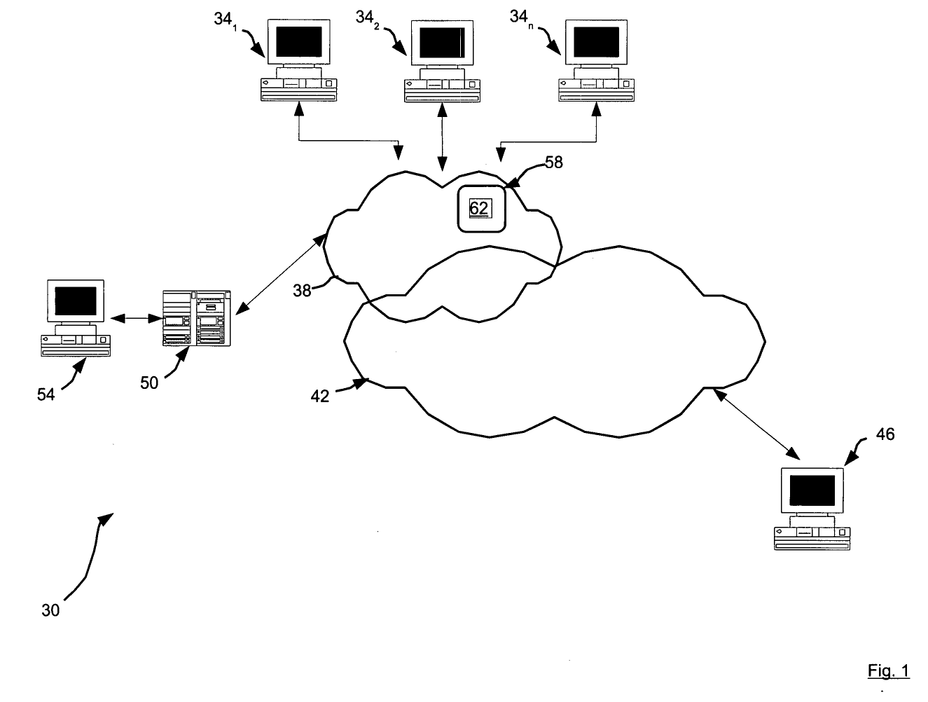

Referring now to FIG. 1, a system for traffic analysis is indicated generally at 30. System 30 comprises a plurality of subscriber units 34₁, 34₂ . . . 34ₙ (generically referred to herein as subscriber unit(s) 34) that connect to a service provider network 38, which in turn connects to the Internet 42. Those of skill in the art should recognize that service provider network 38 is itself actually part of Internet 42, and network 38 and Internet 42 are shown separately herein to facilitate explanation of certain features of the present embodiments, as will be explained in greater detail below.

Subscriber units 34 are thus provided access to Internet 42, and each other, via service provider network 38. In a present embodiment, subscriber units 34 are stand-alone personal computers with modems or other types of network interfaces that allow subscriber units 34 to communicate over network 38 and Internet 42. Subscriber units 34 can, however, be any type of computing entity, such as laptop computers, personal digital assistants, cell phones, and/or can include intranets, web servers, mail servers, etc. that connect to Internet 42 via network 38.

Subscriber units 34 are also able to access other units 46 that are connected to Internet 42 and accordingly, network 38 and Internet 42 provide a conduit through which subscriber units 34 and the other units 46 can communicate with each other. Like subscriber units 34, units 46 can also be any type of computing entity, such as laptop computers, personal digital assistants, cell phones, and/or can include intranets, web servers, mail servers, etc. that connect to Internet 42. Subscriber units 34 and unit 46 each have their own unique Internet Protocol (“IP”) address so that their location can be uniquely identified in Internet 42.

System 30 also includes a default router 50 which has no unique IP address in Internet 42, and, as will be explained in greater detail below, any traffic which enters network 38 that is unrouted will be sent to default router default router 50. Default router 50 is operable to act as a default route for any unrouted traffic in network 38.

As used herein, the term “routed traffic” refers to traffic that is destined for an IP address belonging to a computing entity (such as one of units 34 or unit 46) that actually exists in the global routing table of Internet 42. In contrast, the terms “unrouted traffic” and “non-routed traffic” refer to traffic that is destined for an IP address that does not exist in the global routing table of Internet 42, and is therefore otherwise undeliverable without the presence of default router 50. Also as used herein, the term “Bogon space” refers to those IP addresses that are associated with unrouted traffic.

Default router Default router 50, in turn, is connected to a traffic analyzer 54, which is operable to examine traffic sent to default router 50, as will be explained in greater detail below.

Network 38 also includes at least one router 58 associated with a routing table 62 that is accessible by subscriber units 34 to route traffic in network 38 and Internet 42 to its appropriate destination. Thus, where traffic in network 38 is routed, in that it is destined for an IP address that exists in Internet 42, then table 62 directs that traffic to the appropriate unit 34 or unit 46. However, where traffic within network 38 is unrouted, then table 62 directs that traffic to default router default router 50. Table I shows an exemplary routing table 62 that can be associated with router 58. As will be readily understood by those of skill in the art, while not shown in Table I, routing table 62 includes the other known elements of routing tables such as a next-hop address, destination prefix etc.

TABLE I
Routing Table 62

| | Unit Reference | |
|---|---|---|
| Entry Number | Number | IP Address |
| 1 | 34₁ | 111.0.34.1 |
| 2 | 34₂ | 111.0.34.2 |
| 3 | 34₃ | 111.0.34.2 |
| 4 | 46 | 111.0.46.0 |
| 5 | 50 | 0.0.0.0/0 |
| | | (All other IP addresses) |

Those of skill in the art should recognize that Entry Number 5 in Table I reflects Bogon space in Internet 42. Entry Number 5 is essentially a default destination picked by router 58 as a last resort, in the event that none of the other entries in routing table 62 match a destination IP address. In other words, Entry Number 5 reflects all IP addresses that do not otherwise have an explicit routing entry in the global routing table of Internet 42, and so router 58 chooses default router 50 as the default route for that particular traffic.

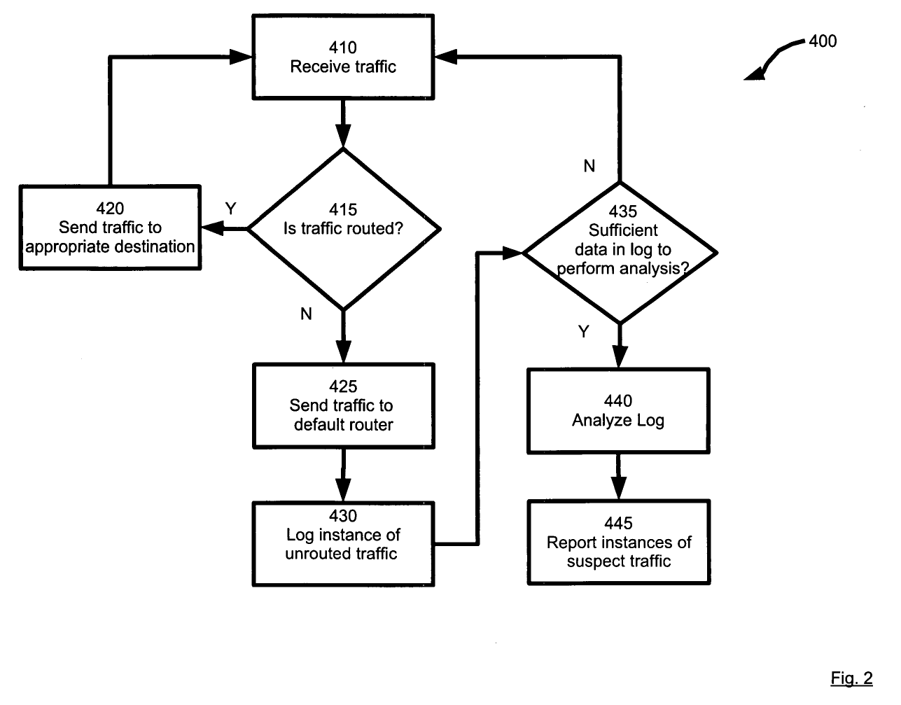

Referring now to FIG. 2, a method for analyzing traffic is indicated generally at 400. In order to assist in the explanation of the method, it will be assumed that method 400 is operated using system 30. Furthermore, the following discussion of method 400 will lead to further understanding of system 30 and its various components. (However, it is to be understood that system 30 and/or method 400 can be varied, and need not work exactly as discussed herein in conjunction with each other, and that such variations are within the scope of the present invention.)

Beginning first at step 410, traffic is received. In system 30, Internet traffic is received by router 58 from one of the subscriber units 34. As will be understood by those of skill in the art, part of the information included in the traffic sent by subscriber unit 34 will include a destination IP address for that traffic. Accordingly, once step 410 is completed method 400 will advance to step 415, at which point a determination is made as to whether the traffic received at step 410 is routed or unrouted. If the destination IP address embedded in the traffic is found in one of the Entry Numbers One—Four of Table I, then the traffic will be considered “routed”, and method 400 will then advance to step 420 and the traffic received at step 410 will be routed to the appropriate destination in the usual manner.

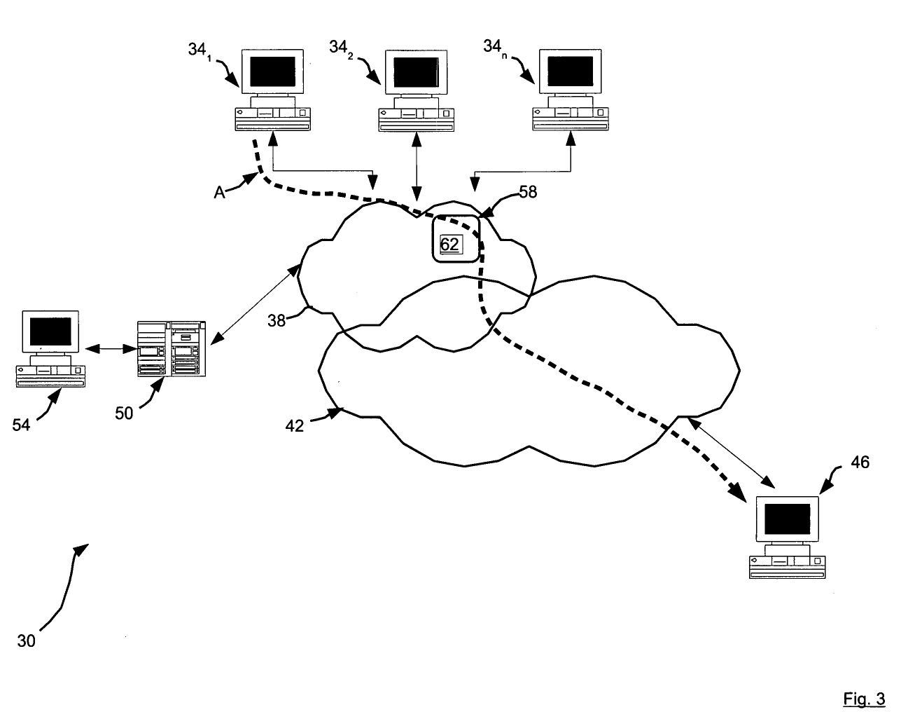

An example helps to further explain the above cycle of steps 410-420. Suppose, at step 410, subscriber unit 34₁ sends traffic to router 58 that includes a destination IP address of 111.0.46.0. At step 415, router 58 will determine that destination IP address of 111.0.46.0 appears in Entry Number Four of Table I, and therefore router 58 will determine that the received traffic is routed. At step 420, router 58 will, using Table I, determine that the received traffic is destined for unit 46, and will accordingly send the received traffic to unit 46 through Internet 42 in the usual manner. The foregoing example is represented in FIG. 3, which includes a dotted line “A” representing the resulting pathway of the routed traffic from subscriber unit 341, through router 58 and to unit 46.

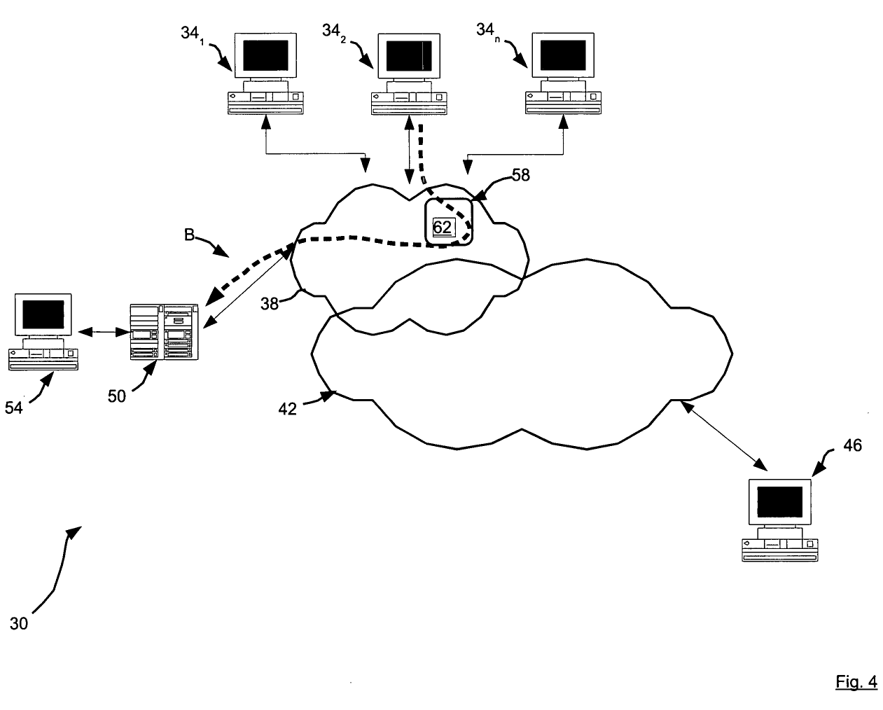

However, if, at step 415 it is determined that the traffic received at step 410 is not routed, then method 400 advances from step 415 to step 425. An example helps to explain how method 400 arrives at step 425. Suppose, at step 410, subscriber unit 342 sends traffic to router 58 that includes a destination IP address of“111.111.111.111”. At step 415, router 58 will determine that the destination IP address “111.111.111.111” does not appear in any of Entry Numbers One through Four of Table 1, and therefore router 58 will determine that the received traffic is “not routed”, and will therefore rely on the default routing pathway in Entry Number Five of Table I. At step 425, router 58 will, using Table I, determine that the received traffic is not routed, and will accordingly send the received traffic to default router default router 50. The foregoing example is represented in FIG. 4, which includes a dotted line “B” representing the resulting pathway of the unrouted traffic from subscriber unit 342, through router 58 and to default router default router 50.

When method 400 advances to step 430, an instance of the unrouted traffic sent at step 410 is logged. When implemented in system 30, default router 50 will pass the traffic it received at step 425 to analyzer 54, and populate a record in a log stored in analyzer 54 that includes data about the unrouted traffic. In the present embodiment, default router 50 effects the passing of traffic to analyzer 54 by changing the Bogon IP address to an address associated with the analyzer 43. Table II shows an example of a structure of such a log as stored in analyzer 54.

TABLE II
Unrouted traffic log stored in analyzer 54

| | | | Source | | Destination |
|---|---|---|---|---|---|
| Entry | | Source IP | Port/ | Destination IP | Port/ |
| Number | Time | Address | Protocol | Address | Protocol |
| 1 | 0:00:00 | 111.0.34.2 | 2000/ | 111.111.111.111 | 135/TCP |
| | | | TCP | | |

In the present embodiment, Table II includes seven columns. Column 1, Entry Number, is simply and index of the particular entry in the log. Column 2, “Time”, is a time stamp of when a particular entry was received by unit 50. Column 3, “Source IP Address”, is the IP address of the unit 34 from which the traffic originated. Column 4, “Source Port/Protocol” is the particular port on the source unit 34 from which the traffic originated combined with the type of protocol of the traffic being sent from “Destination IP Address” is the exact IP address that was indicated in the unrouted traffic, and therefore reflects the underlying reason the particular entry is being populated in the first place. Column 6, “Destination Port/Protocol” is the particular port to which the traffic was destined, combined with the type of protocol.

Other fields not shown in Table II, can include well-known fields associated with Internet routing, including: interface index in; interface index out; next hop; number of octets in packet; Type of Service (TOS) bit; packet number (i.e. the flow of traffic between the source and destination); byte count (i.e. the amount of bytes you in the flow); autonomous system number for destination (i.e. the identity of the network in Internet 42 to which, autonomous system for source (i.e. the identity of network 38). Other fields that can be included in Table II will now occur to those of skill in the art.

Table II is shown as including one entry resulting from the performance of step 430, which corresponds with the unrouted traffic example shown in FIG. 4. In particular, Column 1, Entry Number, is populated with the value “1”, indicating that this is the first entry in the log. Column 2, “Time”, is populated with the time “0:00:00”, indicating that the event occurred at midnight. (While not included in Table II, it is contemplated that Table II would typically include a date stamp as well as a time stamp.) Column 3, “Source IP Address”, is populated with the value “111.0.34.2”, corresponding to the IP address of subscriber unit 342, the particular unit 34 from which the unrouted traffic originated. Column 4, “Source Port/Protocol” is populated with the value “2000TCP”, indicating the traffic originated from port 2000 in TCP format from subscriber unit 342. (Column 4 can, of course, be populated with any of variety of ports and protocols (such as UDP, ICMP) and any other port and protocol from which it is possible to originate traffic). Column 5, “Destination IP Address” is populated with the value “111.111.111.111”, the exact IP address that was indicated in the unrouted traffic. Column 6, “Destination Port/protocol” is populated with the value “TCP/135”, indicating the traffic was of the type TCP and was destined for the port number 135. (Column 6 can, of course, be populated with any of a variety of ports and protocols (such as TCP, UDP, ICMP)and any other port to which it is possible to deliver traffic).

It is to be understood that the contents and structure of Table II are just examples, and that the various components and elements of Table R will conform with commonly used standards associated with the ports, protocols etc.

Next, method 400 advances from step 430 to step 435, at which point it is determined whether a sufficient amount of data exists in the log to perform an analysis. The criteria used to make the determination at step 435 is not particularly limited, and in certain circumstances step 435 can be eliminated altogether if it is desired to configure system 30 to react to any instance of unrouted traffic. In a present embodiment, however, the criteria used to determine whether a sufficient amount of data exists in the log shown in Table II is based on predefined intervals, and in the present embodiment the interval is hourly. In other words, at the end of every hour, Table II is deemed to include enough data to perform an analysis. Where at step 435 it is determined that “no”, enough data does not exist (i.e. a one hour period has not elapsed), method 400 returns step 410 and additional traffic is received and processed as previously described. Where, at step 435, it is determined that “yes”, enough data does exist, method 400 advances to step 440, at which point the log is analyzed. At step 445, any instances of suspect traffic that are found as a result of the analysis at step 440 are reported.

It is to be understood that the particular sequence of steps in method 400 described herein is merely exemplary, and that the steps in method 400 (and portions thereof) are cycling on a constant basis to direct traffic through network 38 and Internet 42. Thus, it should be understood that even as steps 425-445 are occurring, steps 410-420 can also be occurring simultaneously as router 58 continues to direct routed traffic to appropriate destinations, and unrouted traffic to default router 50, while default router 50 and analyzer 54 continues to log and analyze unrouted traffic.

Referring again now to step 440, a variety of analytical techniques can be applied to flag suspect traffic and lead to report generation at step 445. For example, assume that subscriber unit 342 is infected with a worm that scans IP addresses in Internet 42 for other units 34 or 46 to infect or assault with a denial of service attack. Also assume that subscriber unit 342 has been continuously connected to network 38 for over one hour. Table mi shows an example of how the traffic log in analyzer 54 will appear after such a two-hour period, as method 400 cycles.

TABLE III
Unrouted traffic log stored in analyzer 54

| | | | Source | | Destina- |
|---|---|---|---|---|---|
| Entry | | Source IP | Port/ | Destination IP | tion Port/ |
| Number | Time | Address | Protocol | Address | Protocol |
| 1 | 0:00:00 | 111.0.34.2 | 2000/TCP | 111.111.111.111 | 135/TCP |
| 2 | 0:01:00 | 111.0.34.2 | 2000/TCP | 111.111.111.112 | 135/TCP |
| 3 | 0:02:00 | 111.0.34.2 | 2000/TCP | 111.111.111.113 | 135/TCP |
| . | . | . | . | . | . |
| . | . | . | . | . | . |
| . | . | . | . | . | . |
| 61 | 1:00:00 | 111.0.34.2 | 2000/TCP | 111.111.111.161 | 135/TCP |
| 62 | 1:01:00 | 111.0.34.2 | 2000/TCP | 111.111.111.162 | 135/TCP |
| 63 | 1:02:00 | 111.0.34.2 | 2000/TCP | 111.111.111.163 | 135/TCP |
| . | . | . | . | . | . |
| . | . | . | . | . | . |
| . | . | . | . | . | . |

Entry Numbers 1-60 will thus be analyzed at step 440 since a one-hour period will have elapsed. Analyzer 54 will group all entries in Table III that originate from the same Source IP Address, and search for patterns that indicate malicious activity. When performing such an analysis, analyzer 54 will note that, once a minute, over the preceding hour, subscriber unit 342 attempted to communicate with sixty different computing entities, none of which exist in Internet 42, and having a sequence of IP Addresses incrementing by a value of one. Due to the regularity of the communication attempts, and the repeated attempts to communicate with non-existent computing entities, at step 440 analyzer 54 would thus flag the activities of subscriber unit 342 as exhibiting behaviour that could be malicious, and at step 445, analyzer 54 would report this behaviour. The actual reporting can be delivered to any interested party, such as the service provider operating network 38 and/or the owner of subscriber unit 34₂, and/or law enforcement agencies so that investigative and/or any necessary corrective action can be taken. If appropriate or desired, such corrective action can also include an immediate block of subscriber unit 34₂ to network 38 pending outcome of an investigation.

It should now be apparent that the example discussed in relation to Table In is merely exemplary, and that a variety of other patterns and thresholds associated therewith can be used to flag malicious activity. For example, where subscriber unit 34₂ has its IP address dynamically assigned to it, and where that IP address changes over the course of the hour (or other relevant time period) during which the worm thereon attempts to infect other computing entities, the Source IP Address in the log would also change over the course that hour. Analyzer 54 can thus be configured to perform an additional step of aggregating entries that are associated with subscriber unit 34₂ by first consulting with the Dynamic Host Configuration Protocol (“DHCP”) server to determine all of the IP addresses that were assigned to subscriber unit 34₂ during that relevant time period. (Instead of a DCHP server, in other embodiments, another product with similar logging features can be used such as RADIUS, or Cisco Systems Tacacs). Having ascertained which entries in the log are associated with a common subscriber unit 34₂, analyzer 54 can then proceed with the analysis.

Analyzer 50 can also be provided with a set of definitions that correspond to behaviours of particular types of known malicious code. For example, where a known worm always looks for the same ports, in the same sequence on the destination computing entity, analyzer 50 can then flag that particular worm. Table IV provides an example of how such a log might appear.

TABLE IV
Unrouted traffic log stored in analyzer 54

| | | | Source | | Destina- |
|---|---|---|---|---|---|
| Entry | | Source IP | Port/ | Destination IP | tion Port/ |
| Number | Time | Address | Protocol | Address | Protocol |
| 101 | 2:01:00 | 111.0.34.2 | ICMP | 111.111.111.111 | ICMP |
| 102 | 2:02:00 | 111.0.34.2 | 2000/TCP | 111.111.111.111 | 135/TCP |

Thus, in Table IV, the log shows that there was a first ICMP packet, followed by a packet originating from 2000/TCP and destined to 135/TCP. Where this particular pattern is indicative of a particular type of worm or virus, (i.e. such as the Nachi virus) then analyzer 50 can include the functionality of specifically identifying the suspected type of malicious activity originating from subscriber unit 34₂.

In general, it should now be apparent to those of skill in the art that analyzer 50 can be provided with a plurality of patterns and/or definitions that it can use when analyzing the traffic log to ascertain or otherwise flag the presence of malevolent code or other malicious activity. Other factors that can be part of a definition include: a) rates of infections of units 34 in network 38; destination IP scan patterns (i.e. where a particular subscriber unit 34 starts scanning [P addresses that are immediately adjacent to the IP address of that particular subscriber unit); packet frequencies; and packet size. Other factors that can be used to create definitions include any definitions that are now known or are developed in the future can be used as well. It should be further apparent that such patterns and definitions can be updated from time to time as different types of malicious activities are discovered and documented. It should also now be apparent that the NETFLOW protocol can be used by analyzer 50 (and its variants) in performing its tasks. (For more information about NETFLOW, see, for example, Center for Discrete Mathematics and Theoretical Computer Science (DIMACS), DIMACS Center/CoRE Building/4th Floor, Rutgers University, 96 Frelinghuysen Road, Piscataway, N.J. 08854-8018 which maintains an ftp site for NETFLOW at ftp://dimacs.rutgers.edu/nub/netflow/).

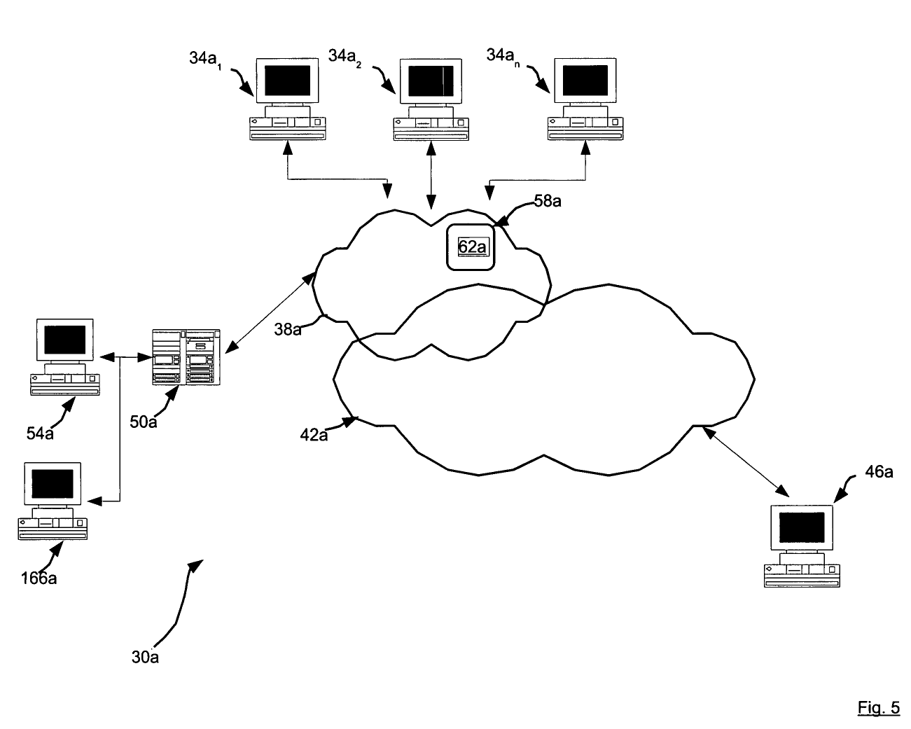

Referring now to FIG. 5, a system for analyzing traffic in accordance with another embodiment of the invention is indicated generally at 30a. System 30a is substantially the same as system 30, and like elements in system 30a to like elements in system 30 have the same reference followed by the suffix “a”. One additional component to system 30a is a “honey-pot” computer 166a. Honey-pot computer 166a is intended to assist analyzer 50 with the analysis and/or diagnosis of certain types of malicious code. In particular, it is known that the Nachi virus, and others, will “ping” target machines, and await responses to those pings, before beginning their attempts at infection. As known to those of skill in the art, the Nachi virus tries to avoid infection attempts on “Bogon Space” space by first attempting to verify the presence of a target computing entity by pinging a given IP address. In this manner, the Nachi virus attempts to avoid detection. To catch these attempted Nachi virus infections, honey-pot computer 166a is operable to respond to an unrouted “ping” that is caught by default router 50, and to then interact with the source subscriber unit 34 that sent the original ping. Depending on the behaviour of the source machine as it interacts with honey-pot computer 166a can ascertain whether the source subscriber unit 34 that is attempting to infect honey-pot computer 166a or is otherwise engaging in malicious activity. Honey-pot computer 166a can also be operable to let itself be infected, by leading the malicious code onto the next stage of infection, and in particular, can wait for a copy of the the malicious code to be planted on honey pot computer 166a for absolute confirmation by means of running a virus definition scan or the like once the malicious code has planted itself on honey pot computer 166a.

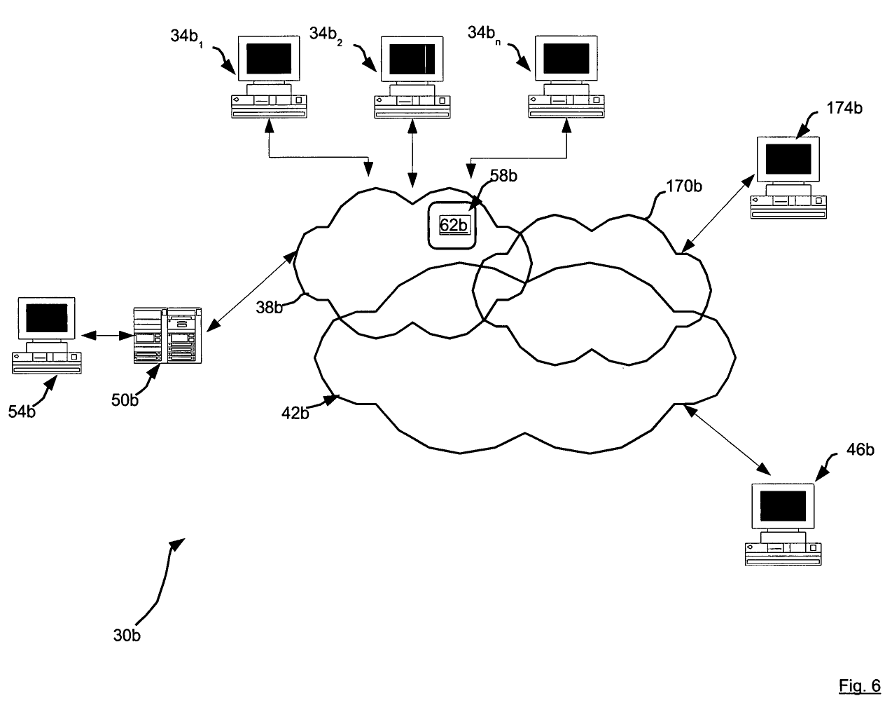

Referring now to FIG. 6, a system for analyzing traffic in accordance with another embodiment of the invention is indicated generally at 30b. System 30b is substantially the same as system 30, and like elements in system 30b to like elements in system 30 have the same reference followed by the suffix “b”. System 30b, however, also includes at least one additional network 170b that is itself part of Internet 42b. Network 170b is comparable to network 38b, except that it is owned and operated by a different service provider than network 38b and the other service providers of Internet 42b. At least one computing unit 174b is connected to network 170b, and computing unit 174b is able to access Internet 42b via network 170b. Unit 174b is like units 34b and units 46b, and is thus any type of computing entity, such as a laptop computer, personal digital assistant, cell phone, and/or can be an intranet, web server, mail server, etc. that connects to Internet 42b.

Table V shows the contents of routing table 62b in system 30b.

TABLE V
Routing Table 62b

| Entry Number | Unit Reference Number | IP Address |
|---|---|---|
| 1 | 34b₁ | 111.0.34.1 |
| 2 | 34b₂ | 111.0.34.2 |
| 3 | 34b₃ | 111.0.34.2 |
| 4 | 46b | 111.0.46.0 |
| 5 | 174b | 111.0.174.0 |
| 6 | 50b | 0.0.0.0/0 |
| | | (All other IP addresses) |

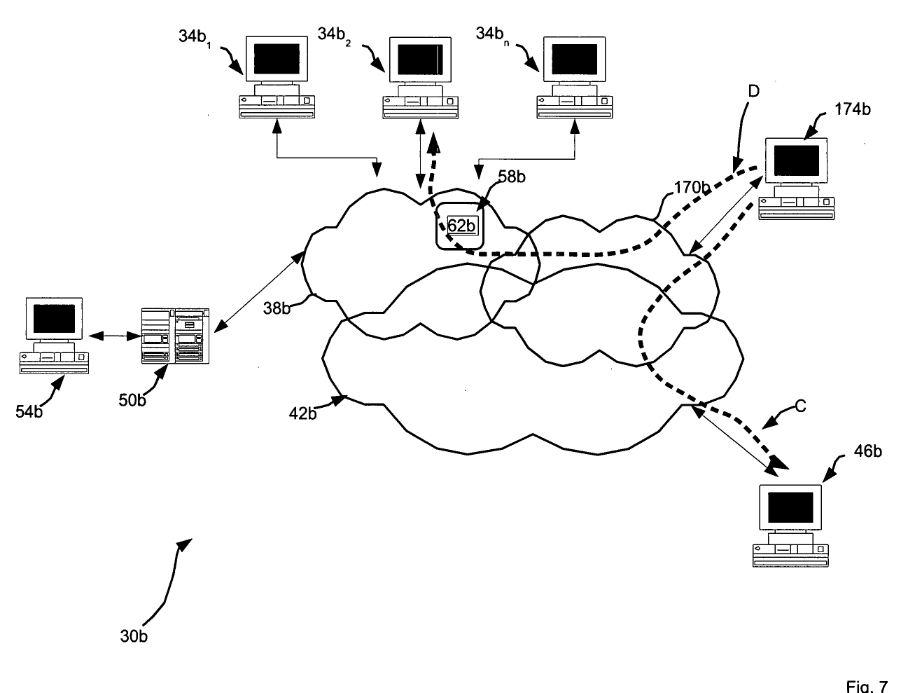

It is also assumed that network 170b is configured (or is supposed to be configured) to only send Internet traffic through network 38b that is destined for subscriber units 34 that are actually a part of network 38b. To achieve this result, any routers and routing tables in network 170b are supposed to be programmed to only utilize network 38b if traffic is actually intended for one of subscriber units 34—otherwise, such traffic should be delivered to Internet 42. In other words, in the event that unit 174b has traffic destined for unit 46b, the path through which such traffic should be carried is directly from network 170b to Internet 42b. FIG. 7 illustrates this path, and includes a dotted line “C” representing the resulting pathway of the traffic from unit 174b to unit 46b. By the same token, in the event that unit 174b has traffic destined for unit 34b₁, the path through which such traffic should be carried is from network 170b to network 38b. FIG. 7 also illustrates this path, and includes a dotted line “D” representing the resulting pathway of the traffic from unit 174b to unit 34b, via network 38b.

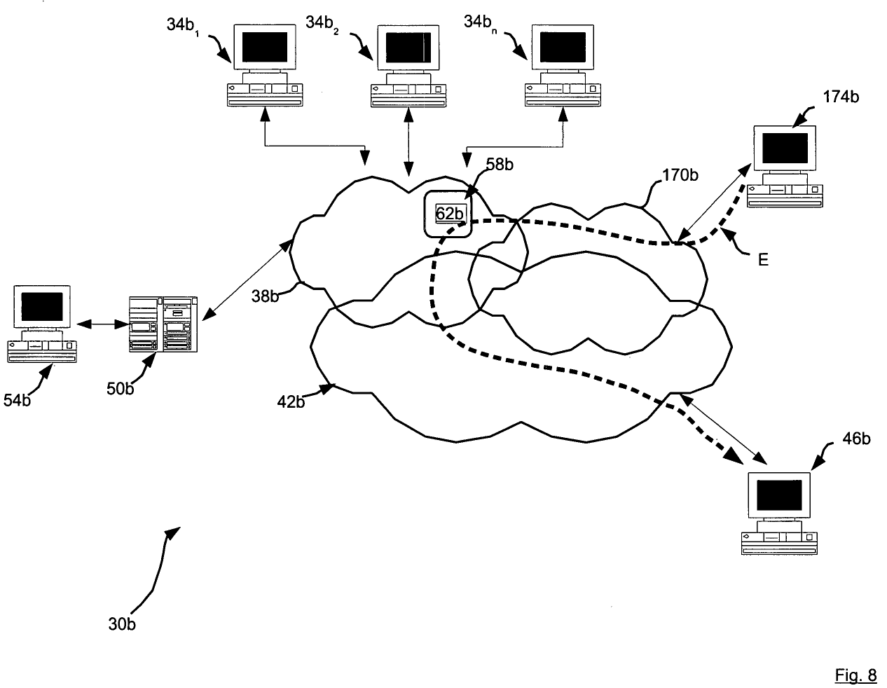

In the event, however, that network 170b in relation to network 38b and the rest of Internet 42b is misconfigured (either accidentally or otherwise), in that traffic destined for unit 46b, is routed through network 38b, system 30b can provide a means, in certain circumstances, for detecting such misconfiguration. FIG. 8 illustrates what happens when such a misconfiguration occurs, showing a dotted line “E” representing the resulting pathway of the traffic from unit 174b to default unit 46b, but which is sent through network 38b due to the misconfiguration.

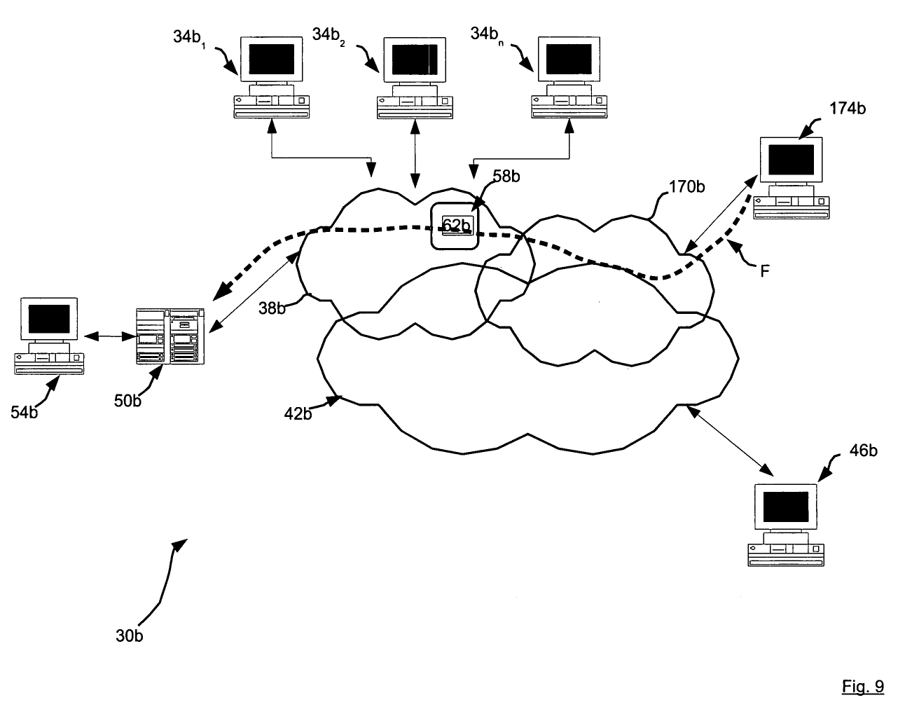

When method 400 is operated on system 30b, a detection of a misconfiguration of the type shown in FIG. 8 can be performed when unrouted traffic originating from unit 174b enters network 38b, as a result of that misconfiguration. FIG. 9 illustrates a path, indicated as a dotted line “F”, of communication of unrouted traffic from unit 174b that enters network 38b, due to the misconfiguration, and which is sent to default router 50b due to the fact the traffic was unrouted. The result of this flow of unrouted traffic from unit 174b will cause the traffic log in analyzer 54b to contain an entry of the type shown in Table VI.

TABLE VI
Unrouted traffic log stored in analyzer 54b

| | | | Source | | Destina- |
|---|---|---|---|---|---|
| Entry | | Source IP | Port/ | Destination IP | tion Port/ |
| Number | Time | Address | Protocol | Address | Protocol |
| 201 | 2:01:00 | 111.0.174.0 | 2000/ | 111.111.111.111 | 135/TCP |
| | | | TCP | | |

Thus, when analyzer 54b reviews Entry Number 201, and examines the fact that the Source IP Address of 111.0.174.0 originates from unit 174b of network 170b, analyzer 54b can flag the fact that such unrouted traffic should never have entered network 38b, and report this fact at step 445. The reporting of such misconfiguration can be used to notify the service provider operating network 170b to correct the misconfiguration, and/or to assess penalties, be they financial or non-financial, against the service provider operating network 170b, in the event that such a misconfiguration represents a breach of contract or other arrangement between the service provider operating network 38b and the service provider operating network 170b.

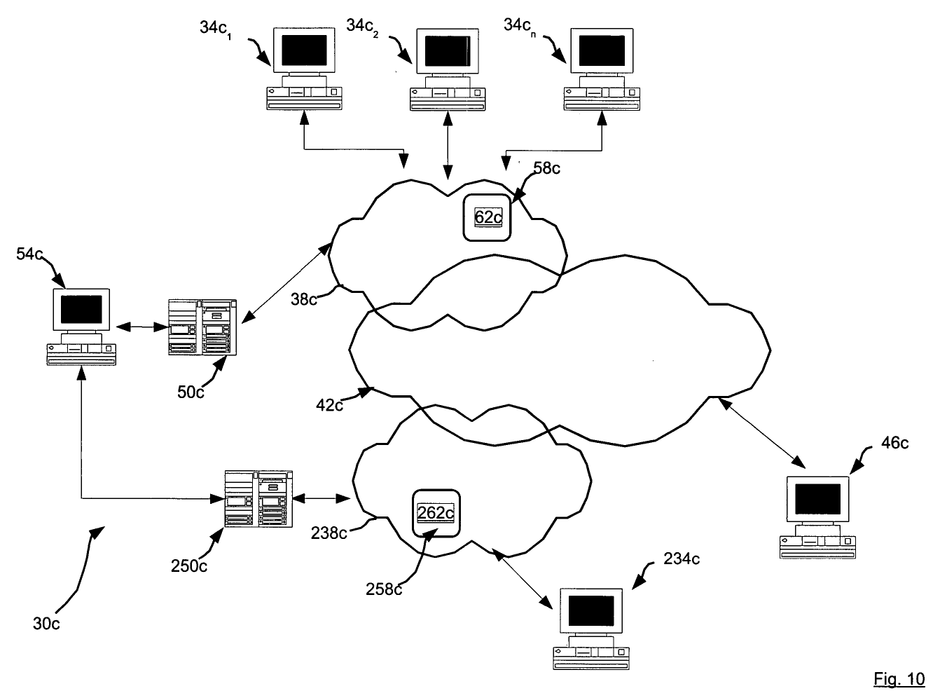

Referring now to FIG. 10, a system for analyzing traffic in accordance with another embodiment of the invention is indicated generally at 30c. System 30c is substantially the same as system 30, and like elements in system 30c to like elements in system 30 have the same reference followed by the suffix “c”. System 30c, however, also includes at least one additional network 238c that is itself part of Internet 42. Network 238c is comparable to network 38c, except that it is operated by a different service provider than network 38c and the other service providers of Internet 42c. At least one computing unit 234c is connected to network 238c, and unit 234c is able to access Internet 42c via network 238c. Unit 234c is like units 34c and units 46c, and is thus any type of computing entity, such as a laptop computer, personal digital assistant, cell phone, and/or can be an intranet, web server, mail server, etc. that connects to Internet 42c. System 30c also includes a default router default router 250c, similar in function and operation to default router default router 50c, in that default router default router 250c is operable to process unrouted traffic within network 238c. By the same token, network 238c also includes a router 258c and a routing table 262c that behave substantially the same as router 58c and table 62c respectively. Table VII shows the contents of routing table 62c, while Table VIII shows the contents of routing table 262c.

TABLE VII
Routing Table 62c

| Entry Number | Unit Reference Number | IP Address |
|---|---|---|
| 1 | 34c₁ | 111.0.34.1 |
| 2 | 34c₂ | 111.0.34.2 |
| 3 | 34c₃ | 111.0.34.2 |
| 4 | 46c | 111.0.46.0 |
| 5 | 234c | 111.0.234.0 |
| 6 | 50c | All other IP addresses |

TABLE VIII
Routing Table 262c

| Entry Number | Unit Reference Number | IP Address |
|---|---|---|
| 1 | 34c₁ | 111.0.34.1 |
| 2 | 34c₂ | 111.0.34.2 |
| 3 | 34c₃ | 111.0.34.2 |
| 4 | 46c | 111.0.46.0 |
| 5 | 234c | 111.0.234.0 |
| 6 | 250c | All other IP addresses |

To summarize Tables VII and VIII, unrouted traffic in network 38c will be sent to default router 50c, and unrouted traffic in network 238c will be sent to router 250c.

Due to the fact that default router 50c and analyzer 54c are proprietary to the service provider operating network 38c, network 38c, default router 50c and analyzer 54c will operate substantially the same as described before in relation to system 30. However, in system 30c, the operator of network 238c configures router 250c to direct all unrouted traffic in network 238c to analyzer 54c. Thus, analyzer 54c differs from analyzer 54 in that analyzer 54c is operable to analyze unrouted traffic in both network 38c and network 238c. In this arrangement, the service provider operating network 238c need not duplicate the complexity and effort of running its own analyzer. In certain embodiments of the invention, the arrangement in system 30c will involve a service-fee charged by the operator of network 38c to the operator of network 238c to perform the analysis function in analyzer 54c for the unrouted traffic in network 238c.

While only specific combinations of the various features and components of the present invention have been discussed herein, it will be apparent to those of skill in the art that desired subsets of the disclosed features and components and/or alternative combinations of these features and components can be utilized, as desired. For example, in system 30, subscribers owning subscriber unit 34 can be offered a subscription service to having analyzer 54 monitor whether a particular subscriber unit 34 is infected. In this variation, a particular subscriber unit 34 would agree to pay a fee to the operator of network 38 in exchange for having analyzer 54 detect and/or diagnose infections (or other types of malicious activity) originating from the particular subscriber unit 34. The fee can be charged on a per-detected infection basis, or as a monthly fee as part of that overall fees for accessing network 38, or according to such other criteria as may be desired. The fee could also include a charge for performing a disinfection or isolation of the infection. As another variation, in system 30, subscribers owning subscriber unit 34 can be offered the opportunity to purchase software that will remove infections from their subscriber units 34 if method 400 (or its variants) determines that their particular subscriber unit 34 is infected. More specifically, where an actual diagnosis of the infection is made, the subscriber can be specifically offered the opportunity to purchase a specific patch (or the like) that is specifically tailored to address the diagnosed infection. Other structures for charging fees or otherwise offering such services to subscribers will now occur to those of skill in the art.

As another variation, system 30 (or its variants 30a, 30b or 30c) can include multiple routers 58, and/or multiple default route generators 50 and/or multiple analyzers 54, and/or multiple honeypots 30a as desired or needed. Similarly, it should be understood that the functionality of default router 50, analyzer 54, or honeypot 30a can be combined into a single computing device.

While in the present embodiments default router 50 sends out the default route to the entire network to attract all traffic destined to the bogon space, in other embodiments it can be desired to configure default router 50 to generate a default route for a subset of bogon space to attract a subset of the unrouted traffic. This can be desirable in situations where the network operator does not want to generate a default route for all unrouted traffic, due to the congestion that could arise due to the large amount of unrouted traffic that would be routed to the default router.

In a further variation, the default router could announce a legitimate and routed IP subnet assigned to the network operator using variations on the foregoing embodiments of the present invention. By doing so, and by looking at traffic destined to that subnet announced by the default router, the system can expand its view and analyzing capability to report on worms (and other activity) that exist or originate on other networks that may or may not be customers to the operator of the network to which the default router is attached, since that subnet is legitimately announced to the world as a routed space. Worms on such other networks can scan this subnet as a part of its normal operation and the traffic will be routed from any part of the world to the default router, and therefore the default router and analyzer can have a global view of the Internet.

The above-described embodiments of the invention are intended to be examples of the present invention and alterations and modifications may be effected thereto, by those of skill in the art, without departing from the scope of the invention which is defined solely by the claims appended hereto.

1. A system for analyzing network traffic comprising:
a plurality of subscriber units and a default router default router interconnected by a network, said network operable to direct routed traffic to an appropriate subscriber unit and further operable to direct unrouted traffic to said default router default route generator; and
an analyzer connected to said default router default router for determining patterns of activity within said unrouted traffic.

2. The system according to claim 1 wherein said activity is selected from the group consisting of worms, viruses, Trojan horses, scanners.

3. The system according to claim 1 wherein said activity is a misconfiguration of a network routing table in a second network adjacent to said network.

4. The system according to claim 3 wherein said misconfiguration is a result of said second network routing traffic to a third network adjacent said network via said network.

5. The system according to claim 3 wherein said misconfiguration is a breach of a service contract between an operator of said network and an operator of said second network.

6. The system according to claim 5 further comprising a means for assessing a penalty against an operator of said second network, said penalty corresponding to said breach of contract.

7. The system according to claim 1 wherein at least one of said patterns is plurality of attempts by one of said subscriber units to send unrouted traffic.

8. The system according to claim 7 wherein said attempts occur at substantially identical intervals of time.

9. The system according to claim 1 wherein at least of said patterns includes a subscriber unit originating unrouted traffic from at least one predefined port and attempting to send traffic to another at least one predefined port.

10. The system according to claim 1 wherein at least one of said patterns includes a subscriber unit originating traffic of a first type of protocol.

11. The system according to claim 1 further comprising a honey pot connected to said analyzer for responding to said unrouted traffic.

12. The system according to claim 11 wherein said honey pot is operable to permit itself to be infected with a malicious code associated with said unrouted traffic.

13. The system according to claim 12 wherein said honey pot includes a malicious code scanner for identifying said malicious code once said honey pot computer is infected.

14. The system according to claim 1 further comprising a means for isolating one of said subscriber units from said network if said analyzer determines a pattern of activity associated therewith is malicious.

15. The system according to claim 1 further comprising a means for notifying one of said subscriber units if said analyzer determines a pattern of activity associated therewith is malicious.

16. The system according to claim 15 further comprising a means for charging a fee to a subscriber associated with said one of said subscriber units.

17. The system according to claim 1 further comprising a means for providing said analyzer with updated definitions of known patterns of malicious traffic.

18. A traffic analyzer comprising:
an interface for connecting to a network, said network operable to interconnect a plurality of subscriber units, said network further operable to direct routed traffic to an appropriate subscriber unit and further operable to direct unrouted traffic to said interface; and,
a processing means connected to said interface, said processing means operable to determine patterns of activity within said unrouted traffic.

19. The analyzer according to claim 18 wherein said activity is selected from the group consisting of worms, viruses, Trojan horses, scanners.

20. The analyzer according to claim 18 wherein said activity is a misconfiguration of a network routing table in a second network adjacent to said network.

21. The analyzer according to claim 20 wherein said misconfiguration is a result of said second network routing traffic to a third network adjacent said network via said network.

22. The analyzer according to claim 20 wherein said misconfiguration is a breach of a service contract between an operator of said network and an operator of said second network.

23. The analyzer according to claim 18 wherein at least one of said patterns is plurality of attempts by one of said subscriber units to send unrouted traffic.

24. The analyzer according to claim 23 wherein said attempts occur at substantially identical intervals of time.

25. The analyzer according to claim 18 wherein at least of said patterns includes a subscriber unit originating unrouted traffic from at least one predefined port and attempting to send traffic to another at least one predefined port.

26. The analyzer according to claim 18 wherein at least one of said patterns includes a subscriber unit originating traffic of a first type of protocol.

27. The analyzer according to claim 18 further comprising a honey pot connected to interface analyzer for responding to said unrouted traffic.

28. The analyzer according to claim 27 wherein said honey pot is operable to permit itself to be infected with a malicious code associated with said unrouted traffic.

29. The analyzer according to claim 28 wherein said honey pot includes a malicious code scanner for identifying said malicious code once said honey pot computer is infected.

30. The analyzer according to claim 18 further comprising a means for instructing said to network isolate one of said subscriber units from said network if said analyzer determines a pattern of activity associated therewith is malicious.

31. The analyzer according to claim 18 further comprising a means for notifying one of said subscriber units if said processing means determines a pattern of activity associated therewith is malicious.

32. The analyzer according to claim 18 further comprising a means for providing said analyzer with updated definitions of known patterns of malicious traffic.

33. The analyzer according to claim 18 wherein said interface is a default router operable to instruct a routing table associated with said network to deliver unrouted traffic to said default route generator.

34. A default router for connecting to a network that interconnects a plurality of subscriber units; said network operable to direct routed traffic in said network to an appropriate subscriber unit; said default router operable to instruct said network to direct unrouted traffic to said default route generator.

35. The default router of claim 34 wherein said network further includes a routing table and wherein said default router instructs said network to direct unrouted traffic by creating an entry in said routing table associated with said default route generator.

36. A network routing table for use in association with a network that interconnects a plurality of subscriber units; said network operable to access said network routing table to direct routed traffic in said network to an appropriate subscriber unit; said network further operable to access said network routing table to direct unrouted traffic in said network to a traffic analyzer.

37. A method of analyzing traffic in a network comprising the steps of:
receiving traffic from at least one of a plurality of subscriber units interconnected by said network;
delivering said traffic to a destination subscriber unit if said traffic is routed;
analyzing said traffic for patterns of activity in said traffic if said traffic is unrouted.

38. The method according to claim 37 wherein said activity is selected from the group consisting of worms, viruses, Trojan horses, scanners.

39. The method according to claim 37 wherein said activity is a misconfiguration of a network routing table in a second network adjacent to said network.

40. The method according to claim 39 wherein said misconfiguration is a result of said second network routing traffic to a third network adjacent said network via said network.

41. The method according to claim 39 wherein said misconfiguration is a breach of a service contract between an operator of said network and an operator of said second network.

42. The method according to claim 41 further comprising the step of assessing a penalty against an operator of said second network, said penalty corresponding to said breach of contract.

43. The method according to claim 37 wherein at least one of said patterns is plurality of attempts by one of said subscriber units to send unrouted traffic.

44. The method according to claim 43 wherein said attempts occur at substantially identical intervals of time.

45. The method according to claim 37 wherein at least of said patterns includes a subscriber unit originating unrouted traffic from at least one predefined port and attempting to send traffic to another at least one predefined port.

46. The method according to claim 37 wherein at least one of said patterns includes a subscriber unit originating traffic of a first type of protocol.

47. The method according to claim 37 further comprising the step of responding to said unrouted traffic.

48. The method according to claim 47 further comprising the step of permitting an infection in a honey pot computer of a malicious code in associated with said unrouted traffic.

49. The method according to claim 48 further comprising the step of, after said permitting step, scanning said honeypot computer to identify said malicious code once.

50. The method according to claim 37 further comprising the step of isolating one of said subscriber units from said network if said pattern of activity associated with said one of said subscriber units is determined to be malicious.

51. The method according to claim 37 further comprising the step of notifying one of said subscriber units if said pattern of activity associated with said one of said subscriber units is determined to be malicious.

52. The method according to claim 51 further comprising the step of charging a fee to a subscriber associated with said one of said subscriber units.

53. The method according to claim 37 further comprising the step of providing updated definitions of known patterns of malicious traffic.

54. The method according to claim 37 further comprising the step of notifying one of said subscriber units if said pattern of activity associated with said one of said subscriber units is determined to be malicious, said notifying including offering a software tool for removing code from said at least one subscriber unit that is responsible for generating such malicious activity.

55. A system comprising:
means for receiving network traffic from at least one subscriber unit coupled to a network; and
means for detecting an infection problem on said subscriber unit with use of said received network traffic.

56. A system according to claim 55, further comprising means for offering to a person associated with the subscriber unit, an application to at least one of protect and destroy the infection problem if an infection problem is detected on the subscriber unit.

57. A system for analyzing network traffic comprising:
a network;
a plurality of subscriber units connected to said network;
a default router connected to said network;
a network router for directing traffic that is:
addressed to one of said subscriber units to a corresponding said subscriber unit; and
unaddressed to any said subscriber unit to said default route generator;
an analyzer connected to said default router for determining patterns of activity within traffic directed to said default route generator.

58. A method of analyzing traffic comprising the steps of:
receiving unrouted network traffic originating from at least one of a plurality of subscriber units; and,
analyzing said traffic for patterns of activity in said traffic.
